(19) United States
(12) Patent Application Publication
(10) Pub. No.: US 2016/0032114 A1
(43) Pub. Date: Feb. 4, 2016

(54) POLYCARBONATE BLENDS EXHIBITING ANTIMICROBIAL BEHAVIOR, EXCELLENT IMPACT STRENGTH, AND COLOR AFTER AGING AT ELEVATED TEMPERATURE AND HUMIDITY

(71) Applicants: Bruce L. HAGER, (US); Michael A. GERACE, (US); John J. CHARLES, (US); James P. MASON, (US); BAYER MATERIALSCIENCE LLC, Pittsburgh, PA (US)

(72) Inventors: Bruce L. Hager, Canonsburg, PA (US); Michael A. Gerace, Slovan, PA (US); John J. Charles, Upper St. Clair, PA (US); James P. Mason, Carnegie, PA (US)

(21) Appl. No.: 14/776,107

(22) PCT Filed: Mar. 13, 2014
(86) PCT No.: PCT/US2014/025457

§ 371 Date: Sep. 14, 2015

Related U.S. Application Data
(60) Provisional application No. 61/790,980, filed on Mar. 15, 2013.

(51) Int. Cl. C09D 5/14; C09D 7/12

(52) U.S. Cl. CPC C09D 5/14; C09D 7/1216; C08K 2003/328

(57) ABSTRACT

The present invention provides a polycarbonate blend which exhibits antimicrobial behavior while retaining excellent impact strength and color when aged at elevated temperature and humidity, even at significantly increased levels of antimicrobial additive. The compositions of the present invention are based on silver sodium zirconium phosphate of the composition: NaₓH_{y}Ag_{z}Zr₂(PO₄)₃, where x+y+z=1.

### FIELD OF THE INVENTION

The present invention relates in general to, plastics and more specifically to polycarbonate blends which exhibit antimicrobial behavior, excellent impact strength, and color after aging at elevated temperature and humidity.

### BACKGROUND OF THE INVENTION

U.S. Pat. No. 4,906,466, issued to Edwards et al., discloses an antimicrobial composition for topical use or for incorporation into a coating or structural composition comprises an antimicrobial silver compound, preferably silver chloride, deposited on a physiologically inert oxidic synthetic particulate support material in particulate form. A preferred support material is titania containing one or more of the crystalline forms anatase, rutile, and brookite.

U.S. Pat. No. 5,180,586, issued to Sato et al., describes an acaricidal composition, comprising one or more compounds selected from among methyl cinnamate, ethyl cinnamate, n-propyl cinnamate, isopropyl cinnamate, n-butyl cinnamate, isobutyl cinnamate, isoamyl cinnamate, n-hexyl cinnamate, allyl cinnamate, cinnamyl acetate, cinnamyl propionate, cinnamyl n-butyrate, cinnamyl isobutyrate, p-cresyl acetate, p-cresyl butyrate, p-eresyl isobutyrate, p-methylbenzyl propionate, .beta.-phenoxyethyl alcohol, phenoxyethyl acetate, phenoxyethyl propionate, phenoxyethyl n-butyrate, phenoxyethyl isobutyrate, methyl phenyl acetate, ethyl phenyl acetate, dibenzyl ether, heliotropin, methyl diphenyl ether and 2-methyl-1-methylbicyclo[2,2,1]hept-5-en-2-yl)-1-penten-3-ol as an active ingredient.

U.S. Pat. No. 5,298,252, issued to Hagiwara et al,, describes a silica gel based heat-resistant and weatherproof antimicrobial composition having an aluminosilicate layer on the surfaces of pores in the silica gel as substituted by silver and an optional antimicrobial metal, the composition containing ion-exchangeable metals that are chiefly an alkali metal and that are present in an amount of up to 2.57 mmol per gram of the composition on an anhydrous basis,

U.S. Pat, No. 5,413,789, issued to Hagiwara et al. describes an antimicrobial polymer composition comprising a polymer and an antimicrobial composition, wherein said antimicrobial composition is composed of a coat of aluminosilicate on the surface of silica gel, wherein said composition has a pore volume of at least 0.3 cm³/g and a specific surface area of at least 100 m²/g, wherein said aluminosilicate coat is composed of either partial or complete substituted ion-exchangeable metal (M) in the aluminosilicate solid coating layer represented by the formula xM_{2/n}O—Al₂O₃-ySiO₂—ZH₂—O, wherein x and y represent the numbers of molecules of the metal oxide and silicon dioxide, respectively, M is an ion-exchangeable metal, n is the atomic valence of M, and z is the number of molecules of water, wherein said partial or completely substituted ion-exchangeable metal is selected from the group consisting of silver, copper, zinc, mercury, tin, lead, bismuth, cadmium, chromium and mixtures thereof and wherein said polymer is a halogenated or non-halogenated organic polymer.

U.S. Pat. No. 5,503,840, issued to Jacobson et al., describes an antimicrobial composition of titanium dioxide, barium sulfate, zinc oxide particles, and mixtures thereof having successive coatings of silver, in some cases a coating of zinc and/or copper compounds such as zinc oxide, copper (II) oxide and zinc silicate; silicon dioxide: alumina; and a dispersion aid such as dioctyl azelate.

U.S. Pat. No, 5,698,212, issued to Hagiwara discloses an antimicrobial polymer composition said to have superior weatherability and discoloration resistance to those of the prior art. The antimicrobial polymer composition comprising a polymer and an antimicrobial composition has an antimicrobial coat of an aluminosilicate on the surface of silica gel, wherein said aluminosilicate containing antimicrobial metal ions, characterized in that said antimicrobial polymer composition further comprises thiabendazole.

U.S. Pat. No. 5,698,229, issued to Ohsumi et al., describes an antimicrobial composition, characterized by containing an inorganic compound on Which silver ion is supported and a compound represented by the following formula [2];

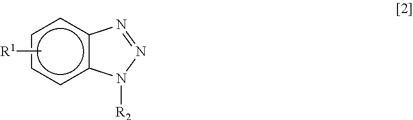

wherein R¹ is hydrogen or a lower alkyl group and R² is hydrogen or an alkali metal.

U.S. Pat. No. 5,827,524, issued to Hagiwara et al., provides an antimicrobial polymer composition comprising a novel crystalline antimicrobial composition. More particularly, the disclosure provides an antimicrobial polymer composition comprising a crystalline antimicrobial composition and a polymer, wherein the crystalline antimicrobial composition comprises a crystalline silicon dioxide containing silver ions and one or two optional metal ions selected from the group consisting of zinc and copper.

U.S. Pat. No. 5,848,995, issued to Walder discloses an anti-infective medical article comprising a hydrophilic polymer having silver chloride bulk distributed therein. The hydrophilic polymer may be a laminate over a base polymer. A method for making the article includes contacting the hydrophilic polymer with a solution of a soluble silver salt followed by a solution of a soluble chloride to give silver chloride bulk distributed throughout the polymer matrix is also provided. The polymer may then be melt processed, such as by extruding, or coextruding with the base polymer.

U.S. Pat. No 6,120,790, issued to Kuratsuji et al, provide thermoplastic resin compositions characterized in that an antimicrobial/fungistatic agent, and particularly an inorganic antimicrobial/fungistatic agent, is compounded with a copolymer containing a polyether chain as a constituent unit, such as a polyether/polyamide copolymer, a polyether/polyester copolymer or a polyether urethane, for example, at 0.05-20 wt. %, and thermoplastic resin compositions which comprise a thermoplastic resin, an antimicrobial/fungistatic agent and a copolymer having a polyether chain as a constituent unit.

U.S. Pat. No, 6,187,456, issued to Lever provides improvements in inhibiting undesirable discoloring of plastic articles within which silver-based antimicrobials have been introduced. Such a method requires the utilization of very low amounts of acid scavengers or stabilizers such as aluminum-mane sum hydroxycarbonate, otherwise known as hydrotalcite (and not a zinc-based compound). Such hydrotalcites are said to be very low in cost, easy to handle, and, utilized in very low levels in combination with a silver-based antimicrobial within a plastic composition, and surprisingly substantially prohibits the generation of Un wan ted aesthetically displeasing colors,

U.S. Pat. No. 6,329,450, issued to Ogre et al describes a blend of polymeric materials comprising; (A) of from about 1 to about 80 percent by weight (based on the combined weights of Components A and B) of at least one substantially random interpolymer; wherein said interpolymer; (1) contains of from about 0.5 to about 50 mole percent of polymer units derived from; a) at least one vinyl or vinylidene aromatic monomer, or b) at least one hindered aliphatic or cycloaliphatic vinyl or vinylidene monomer, or c) a combination of at least one vinyl or vinylidene aromatic monomer and at least one hindered aliphatic or cycloaliphatic vinyl or vinylidene monomer; (2) contains of from about 50 to about 99.5 mole percent of polymer units derived from at least one aliphatic α-olefin having from 2 to 20 carbon atoms; (3) has a melt index (I₂) of from about 0.01 to about 100 g/10 min; and (4) has a molecular weight distribution (M₂/Mₙ) of from about 1.5 to about 20; (B) of from about 20 to about 99 weight percent based on the combined weights of Components A, and B of one or more engineering thermoplastics.

U.S. Pat. No, 6,497,868, issued to Tanahashi provides a graft polymer which is characterized in that it is formed by graft polymerization of structural units containing, a quaternary ammonium group represented by general formula (A),

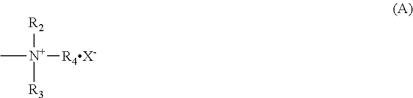

(R₂ and R₃ each represent an alkyl group with from 1 to 3 carbons, and R₄ represents an alkyl group with from 3 to 18 carbons. X represents at least one type of ion selected from halogen, sulphate, hydroxide and carboxylic acid preferably to graft polymer where the structural units containing a quaternary ammonium group represented by general formula (A) are structural units which are represented by general formula (I),

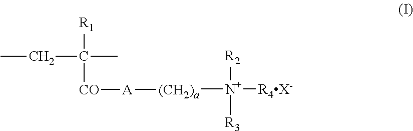

(R₁ represents at least one species selected from hydrogen, the methyl group and the ethyl group, and a represents an integer in the range 1 to 12. A represents at least one species selected from O, S and NR₅. R₅ represents hydrogen or an alkyl group with 1 to 12 carbons.) or graft polymer formed by the grab polymerization of structural units containing a quaternary ammonium group and structural units containing an alkoxypolyalkylene glycol moiety represented by the general formula (B),

—(R₅O)ₙR₆ (B)

Tanahashi states that by applying or incorporating the graft polymer to/in medical devices which are left in the body for a long period, it is possible to prevent microbial infection arising via these medical devices.

U.S. Pat. Nos. 6,716,895; 6,949,598 and 7,179,849, all issued to Terry disclose antimicrobial compositions, methods for the production of these compositions, and use of these compositions with medical devices, such as catheters, and implants. The compositions of Terry are said to advantageously provide varying release kinetics for the active ions in the compositions due to the different water solubilities of the ions, allowing antimicrobial release profiles to be tailored for a given application and providing for sustained antimicrobial activity over time. More particularly, Terry relates to polymer compositions containing colloids comprised of salts of one or more oligodynamic metal, such. as silver. The process disclosed, includes mixing a solution of one or more oligodynamic metal salts with a polymer solution or dispersion and precipitating a colloid of the salts by addition of other salts to the solution which react with some or all of the first metal salts. The compositions are said to be able to be incorporated into articles or employed as a coating on articles such as medical devices.

U.S. Pat. No. 5,905,711, issued to Tullo et al., provide an antimicrobial agent which includes an oligodynamic metal ion in a hydrophilic polymer binder or carrier. In one embodiment, the metal ion is silver and the hydrophilic polymer is polyurethane. According to a method of the invention, the antimicrobial agent is dissolved in dimethyl acetamide DMA, applied to paper by squeegee or the like and dried in an oven to flash off the solvent. The antimicrobial agent can be applied to other products by spraying and/or dipping and the drying to flash off solvent. A method of rendering a polymeric medical device antimicrobial is also disclosed.

U.S. Pat. No. 7,202,293, issued to Kimura describes a resin composition said to have excellent dispersibility, discoloration resistance and antimicrobial properties made by blending a resin (A) with an antimicrobial agent (B) in which at least one kind of metal ion selected from the group consisting of silver, copper, zinc and tin which is supported on zeolite, and an antimicrobial, agent (C) that includes a silver ion-containing phosphate as an active ingredient, or an antimicrobial agent (D) made of a soluble glass powder containing silver ion,

U.S. Pat. No, 7,541,418, issued to Gerace et al., discloses a transparent antimicrobial thermoplastic molding composition. The composition contains aromatic polycarbonate resin and 0.01 to 3.8 of an antimicrobial compound conforming to formula (1) AgₓM¹_{b}M²₂(PO₄)₃ (I) wherein M¹ is at least one ion selected from the group consisting of alkali metal ion, alkaline earth metal ion, ammonium ion and hydrogen ion. M² a tetravalent metal selected from the group consisting of Ti, Zr and Sn, and were a and b are positive numbers where a+mb=1 where in is a valence of M¹, the percent being relative to the weight of the polycarbonate. The composition is said to be suitable for molding articles having good appearance and surface qualities.

Kikuchi in JP 06-240125, describes a resin composition obtained by blending (A) 100 pts.wt thermoplastic resin containing an aromatic polycarbonate resin, composed of a dihydric phenol (preferably bisphenol A) and a carbonate precursor (e.g. phosgene) and having 18000-40000 viscosity-average molecular weight and/or ≦50wt. % polyester resin, etc., with (B) 0.1-5 pts.wt, (preferably 0.5-2 pts.wt.) antimicrobial calcium phosphates composed of hydroxyapatite, etc., containing antimicrobial metallic ions (preferably ions such as silver or copper) supported in an amount of preferably 0.0001-5 wt. % based on the calcium phosphate and (C) 0.01-1 pt.wt. (preferably 0.02-0.2 pt.wt.) phosphorus-based stabilizer (preferably trimethyl phosphate).

JP 09-216999 in the name of Ito, provides an antimicrobial preparation comprising a glass, comprised of P₂O₅: 40 to 55 mol %, ZnO: 35 to 45 mol %, Al₂O₃: 5 to 15 mol %, and B₂O_{3: 1} to 10 mol %, and containing Ag₂O in an amount of 0.3 to 1.0 wt. % based on 100 pts.wt. glass composition is added in the form of a powder having a particle diameter of not more than 10 μm to a polycarbonate resin in an amount of 0.3 to 1.0 wt. % based on 100 g of the resin.

All known inorganic antimicrobial additives used to protect polycarbonate blends from microbial or fungal attack when added at commercially viable concentrations, result in materials with reduced impact strength. In addition, polycarbonate blends used on these known antimicrobial additives exhibit discoloration and darkening when these blends are exposed to conditions of elevated temperature and humidity.

SUMMARY OF THE INVENTION

The present invention provides a polycarbonate blend which exhibits antimicrobial behavior while retaining excellent impact strength and color when aged at elevated temperature and humidity, even at significantly increased levels of antimicrobial additive. The compositions of the present invention are based on silver sodium zirconium phosphate of the composition: NaₓH_{y}Ag_{z}Zr₂(PO₄)₃, where x+y+z=1.

These and other advantages and benefits of the present invention will be apparent from the Detailed Description of the Invention herein below,

### DETAILED DESCRIPTION THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

The present invention provides a thermoplastic molding composition comprising a polycarbonate/ABS blend and 0.1 to 40 weight percent of an antimicrobial compound conforming to formula (I)

NaₓH_{y}Ag_{z}Zr₂(PO₄)₃ (I)

wherein x+y+z=1, and wherein the weight percent is based on the weight of the composition.

Surprisingly polycarbonate blend compositions of the invention exhibit antimicrobial behavior while retaining their excellent impact strength and color when aged at elevated, temperature and humidity, even at significantly increased levels of antimicrobial additive. The compositions of this invention are based on silver sodium zirconium phosphate of composition NaₓH_{y}Ag_{z}Zr₂(PO₄)₃, where x+y+z=1, marketed under the names of ALPHASAN RC 2000 (10% silver) and ALRHASAN RC 5000 (3.8% silver), and sold by Milliken Chemical Co. The known inorganic based silver-containing additives are based on soluble glass (Ishizuka Glass), zeolite (Agion) and ceramic (Sanitized) carriers.

Suitable polycarbonate resins for preparing the composition of the present invention are homopolycarbonates and copolycarbonates, both linear or branched resins and mixtures thereof.

The polycarbonates have a weight average molecular weight of preferably 10,000 to 200,000, more preferably 20,000 to 80,000 and their melt flow rate, per ASTM D-1238 at 300° C., is preferably 1 to 65 g/1.0 min, more preferably 2 to 35 g/10 min. They may be prepared, for example, by the known diphasic interface process from a carbonic acid derivative such as phosgene and dihydroxy compounds by polycondensation (See, German Offenlegungsschriften 2,063,050; 2,063,052; 1,570,703; 2,211,956; 2,211,957 and 2,248,817; French Patent 1,561.518; and the monograph by H. Schnell, “Chemistry and Physics of Polycarbonates”, Interscience Publishers, New York, N.Y., 1964).

In the present context, dihydroxy compounds suitable for the preparation of the polycarbonates of the invention conform to the structural formulae (1) or (2) below.

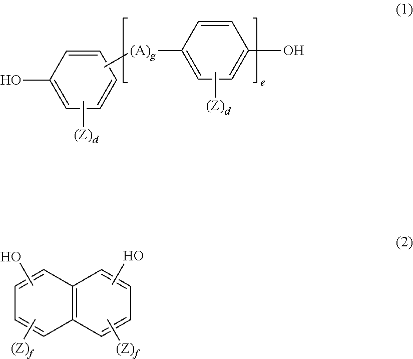

wherein
A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO₂ or a radical

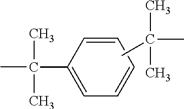

conforming to
e and g both denote the number 0 to 1;
denotes F, Cl, Br or C₁-C₄-alkyl and if several Z radicals are substituents in one aryl radical, they may he identical or different from one another;
d denotes an integer of from 0 to 4; and
f denotes an integer of from 0 to 3.

Among the dihydroxy compounds useful in the practice of the invention are hydroquinone, resorcinol, his-(hydroxyphenyl)-alkanes, bis(hydroxy-phenyl)-ethers, bis-(hydroxyphenyl)-ketones bis-(hydroxy-phenyl)-sulfoxides, bis-(hydroxyphenyl)-sulfides, bis-(hydroxyphenyl)-sulfones, and α,α-bis-(hydroxyphenyl)-diisopropylbenzenes, as well as their nuclear-alkylated compounds. These and further suitable aromatic dihydroxy compounds are described, for example, in U.S. Pat. Nos. 5,401,826, 5,105,004; 5,126,428; 5,109,076; 5,104,723; 5,086,157; 3,028,356; 2,999,835; 3,148,172; 2,991,273; 3,271,367; and 2,999,846, the contents of which are Incorporated herein by reference.

Further examples of suitable bisphenols are 2,2bis-(4-hydroxyphenyl)-propane (bisphenol A), 2,4-bis-(1-hydroxyphenyl)-2-methyl-butane, 1,1-bis-(4-hydroxyphenyl)-cyclohexane, α,α′-bis-(4-hydroxy-phenyl)-p-diisopropylbenzene, ethyl-4-hydroxyphenyl)-propane, 2,2-bis-(3-chloro-4-hydroxyphenyl)-propane 4,4′-dihydroxy-diphenyl, bis-(3,5-dimethyl-4-hydroxylphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxy-phenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, α,α′-bis-(3,5-dimethyl-4-hydroxyphenyl)-p-diisopropyl-benzene and 4,4′-sulfonyl diphenol.

Examples of particularly preferred aromatic bisphenols are 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxy-phenyl)-3.3,5-trimethylcyclohexane. The most preferred bisphenol is 2,2-bis-(4-hydroxyphenyl)-propane (bisphenol A).

The polycarbonates of the invention may email in their structure units derived from one or more of the suitable bisphenols.

Among the resins suitable in the practice of the invention are phenolphthalein-based polycarbonate, copolycarbonates and terpoly-carbonates such as are described in U.S. Pat. Nos. 3,036,036 and 4,210,741, both of which are incorporated by reference herein.

The polycarbonates of the invention may also be branched by condensing therein small quantities, e.g., 0.05 to 2.0 mol % (relative to the hisphenois) of polyhydroxyl compounds. Petty carbonates of this type have been described, for example, in German Offenlegungsschriften 1,570,533; 2,116,974 and 2,113,374; British Patents 885,442 and 1,079,821 and U.S. Pat. No 3,544,514, which is incorporated herein by reference. The following are some examples of polyhydroxyl compounds which may be used for this purpose: phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxyphenyl)-ethane; tri -(4-hydroxyphenyl)-phenyl-methane; 2,2-bis-[4,4-(4,4′-dihydroxydiphenyl)]-cyclohexyl-propane; 2,4-bis-(4-hydroxy-1-isopropylidine)-phenol; hydroxy-5′-methylbenzyl)-4-methyl-phenol; 2,4dihydroxybenzoic acid; 2-(4-hydroxy-phenyl)-2-(2,4-dihydroxy-phenyl)-propane and 1,4-bis-(4,4′-dihydroxytri-phenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in U.S. Pat. Nos. 3,028,365; 2,999,846; 3,153,008; and 2,991,273 which are incorporated herein by reference.

The preferred process for the preparation of polycarbonates is the interfacial polycondensation process. Other methods of synthesis in forming, the polycarbonates of the invention, such as disclosed in U.S. Pat. No. 3,912,688, incorporated herein by reference, may be used. Suitable polycarbonate resins are available in commerce, for instance, from Bayer MaterialScience LLC under the MAKROLON name.

The compositions ol'the present invention contain a silver sodium zirconium phosphate of the following composition:

NaₓH_{y}Ag_{z}Zr₂(PO₄)₃,

where x+y+z=1.

Such phosphates are marketed under the names of ALPHASAN RC 2000 (10% silver content) and ALPHASAN RC 5000 (3.8% silver content) by Milliken Chemical Co. Other known inorganic based silver-containing additives are based on soluble glass (Ishizuka Glass), zeolite (Agion Technologies), and ceramic (Sanitized AG) carriers.

The compositions preferably contain from 0.1 to 40 weight percent, more preferably from 0.5 to 30, most preferably from 1 to 15 weight percent, based on the weight of the composition, of the antimicrobial compound. The antimicrobial compound may be present in the compositions of the present invention in an amount ranging between any combination of these values, inclusive of the recited values.

The inventive composition may contain additional functional components including mold release agents, colorants, hydrolytic stabilizers, radiation stabilizers, UV absorbers, antioxidants, surfactants, foaming agents, fillers, extenders, flame retardants and reinforcing agents.

### EXAMPLES

The present invention is further illustrated, but is not to be limited, by the following examples. All quantities given in “parts” and “percents” are understood to be by weight, unless otherwise indicated. In the Examples below, the following materials were used:

| | |
|---|---|
| PC BLEND A | a polycarbonate/ABS blend having a melt flow rate |
| | of about 12 g/10 min (300° C./1.2 kg load) per |
| | ASTM D-1238, commercially available from Bayer |
| | MaterialScience as BAYBLEND T 65; |
| PC BLEND B | a polycarbonate/ABS blend having a melt flow rate |
| | of 12 g/10 min (300° C./1.2 kg load) per ASTM D- |
| | 1238, commercially available from as BAYBLEND |
| | T-85; |
| PC BLEND C | a polycarbonate/ABS/flame retardant blend having a |
| | melt flow rate of about 15 g/10 min (300° C./1.2 kg |
| | load) per ASTM D-1238, commercially available |
| | from Bayer MaterialScience as BAYBLEND FR |
| | 3010; |
| ANTI- | available from Milliken as ALPHASAN RC-2000; |
| MICROBIAL A | |
| ANTI- | ceramic containing silver, commercially available |
| MICROBIAL B | from Sanitized AG as SANITIZED BC A 21-61; |
| ANTI- | zeolite containing silver, commercially available |
| MICROBIAL C | from Agion Technologies as AGION XAJ; |

The polycarbonate compositions of the Examples were prepared by melt extruding the components in a twin-screw extruder operated at 260° C., 200 RPM, and 15.00 kg/hour. The Notched Izod impact strength (NI) at the indicated temperature was determined in accordance with ASTM D-256 using specimens ⅛″ in thickness.

TABLE I

| | | % Darkness Change |
|---|---|---|
| | NI (ft-lb/in) | 7-day aging |
| BLEND A | | |
| Base resin | 11.7 | 1.4 |
| +2% ANTIMICROBIAL A | 12 | 0.1 |
| +10% ANTIMICROBIAL A | 9.2 | 0.2 |
| +2% ANTIMICROBIAL B | 6.1 | 18 |
| +2% ANTIMICROBIAL C | — | — |
| BLEND B | | |
| Base resin | 13.3 | 1.4 |
| +2% ANTIMICROBIAL A | 13.5 | 1 |
| +10% ANTIMICROBIAL A | 10.8 | 0 |
| +2% ANTIMICROBIAL B | 6.9 | 20 |
| +2% ANTIMICROBIAL C | — | — |
| BLEND C | | |
| Base resin | 14.1 | 2.8 |
| +2% ANTIMICROBIAL A | 13.6 | 0.5 |
| +10% ANTIMICROBIAL A | — | — |
| +2% ANTIMICROBIAL B | 2.2 | 20.6 |
| +2% ANTIMICROBIAL C | 3.2 | 3.4 |

As is apparent by reference to Table I, each of the polycarbonate/ABS blends had a slightly reduced Notched Izod impact strength oven at relatively high concentrations of ALPHASAN RC-2000 (silver sodium zirconium phosphate), whereas a small amount of SANITIZED RC A 21-61 (ceramic containing silver) reduced the Notched Izod impact strength by almost 50% in Blends A and B. Blend C exhibited a great reduction in Notched Izod impact strength with the addition of zeolite AGION XAJ. Thus, all of the polycarbonate/ABS blends containing silver sodium zirconium phosphate retained excellent impact strength and color when aged at elevated temperature and humidity, even at significantly increased levels of antimicrobial additive. All of these compositions also maintained their antimicrobial behavior (data not shown).

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is

1. A thermoplastic molding composition comprising a polycarbonate/ABS blend and 0.1 to 40 weight percent of an antimicrobial compound conforming to formula (I)
NaₓH_{y}Ag_{z}Zr₂(PO₄)₃,
where x+y+z=1, and wherein the weight percent is used on the weight of the composition.

2. The composition according to claim i wherein the antimicrobial compound is present in an amount of 0.5 to 30 weight percent.

3. The composition according to clam 1 wherein the antimicrobial compound is present in an amount of 1 to 15 weight percent.

4. An article of manufacture comprising the composition of claim 1.
